(19) United States
(12) Patent Application Publication
(10) Pub. No.: US 2014/0167492 A1
(43) Pub. Date: Jun. 19, 2014

(54) BICYCLE RIM MADE WITH ALUMINUM AND CARBON FIBERS

(71) Applicant: KUNSHAN HENRY METAL TECHNOLOGY CO., LTD, (US)

(72) Inventor: KEE PING THO, JIANGSU (CN)

(73) Assignee: KUNSHAN HENRY METAL TECHNOLOGY CO., LTD., JIANGSU (CN)

(21) Appl. No.: 13/713,171

(22) Filed: Dec. 13, 2012

(51) Int. Cl. B60B 21/02

(52) U.S. Cl. CPC B60B 21/02
USPC 301/95.102

(57) ABSTRACT

A bicycle rim includes an outer rim made by aluminum and initially formed as an elongate member which has two connection ends which are connected to each other to form a ring-shaped rim. The outer rim has two sidewalls and a tire groove is defined between the two sidewalls. The outer rim has at least one rib located in opposite to the tire groove and the at least one rib has a hook-shaped flange. An inner rim made by carbon fibers and is connected to the inner periphery of the outer rim. The inner rim encloses the at least one rib.

### FIELD OF THE INVENTION

The present invention relates to a rim, and more particularly, to a bicycle rim having aluminum-made ribs coated with carbon fibers to reduce the defect rate and increase the strength.

### BACKGROUND OF THE INVENTION

The conventional bicycle rims generally are made by metal, carbon fibers or combination of metal and the carbon fibers. The metal has better heat dissipating feature so that the metal-made rim can be cooperated with brake pads which clamp the two sides of the rim. However, the metal-made rim is heavy. The rim made by carbon fibers is light in weight, tough and durable, however, the heat generating the braking action cannot be released quickly so that the carbon fibers may be peeled off. The combination of the metal and carbon fibers will improve the shortcomings of the bicycle rims made by single material.

The conventional bicycle rim made by the metal and carbon fibers generally uses aluminum alloy to be the ring-shaped portion by connecting two ends of a elongate strip, and the carbon fibers are connected to the inside of the ring-shaped portion to form the bicycle rim.

The connection methods between the metal and the carbon fibers can be cataloged into engagement method and adhere method.

Taiwan Utility Model Application No. 098223508 discloses a rim with an outer rim and an inner rim which is connected to the outer rim and shares a common center with the outer rim. The outer rim has a first face and a second face, wherein the first face has a tire groove defined therein and two flat brake faces are formed on two sides of the tire groove. The tire is engaged with the tire groove and the brake pads contact the brake faces to stop the rim. The second face has two connection grooves in two sides thereof so as to be connected to the inner rim.

Taiwan Utility Model Application No. 098211957 discloses a rim with an outer rim and an inner rim which is connected to the outer rim. The outer rim has two sidewalls and each sidewall has a brake face defined in the outside thereof. A connection rim is connected between the two sidewalls and has two top ribs on the two ends thereof so as to be connected between the two respective mediate portions of the sidewalls. The connection rim further has two lower ribs on the two ends thereof so as to be connected between the two respective lower portions of the sidewalls. A space is defined between the top and lower ribs. The outer rim has a connection surface to which the connection rim is connected.

Each of the connection ends of the outer rim of the Taiwan Utility Model Application No. 098223508 is protruded and forms as a thin plate. The thickness of the connection end becomes thinner so that the connection end is easily deformed when manufacturing the outer rim. The two sides of the inner rim are engaged with the connection grooves of the outer rim and the connection ends are then lifted to match with the inner rim. The connection ends are easily damaged to affect safety.

For Taiwan Utility Model Application No. 098211957, the connection between the lower ribs and the inner rim lacks proper securing mechanism so that the connection may not be perfectly completed, and the inner rim easily drops off.

The present invention intends to provide a bicycle rim which improves the shortcomings of the conventional bicycle rims.

### SUMMARY OF THE INVENTION

The present invention relates to a bicycle rim and comprises an outer rim and an inner rim, wherein the outer rim is made by aluminum and initially formed as an elongate member which has two connection ends which are connected to each other to form a ring-shaped rim. The outer rim has two sidewalls and a tire groove is defined between the two sidewalls. The outer rim has at least one rib located in opposite to the tire groove and the at least one rib has a hook-shaped flange. The inner rim made by carbon fibers and is connected to the inner periphery of the outer rim. The inner rim encloses the at least one rib.

The primary object of the present invention is to provide a bicycle rim and the outer rim is made by aluminum. At least one rib is formed when extruding the outer rim and the at least one rib has a flange. An inner rim is made by carbon fibers and connected to the inner periphery of the outer rim so as to have the bicycle rim with strength, light and durable features.

Another object of the present invention is to provide a bicycle rim made by aluminum and carbon fibers. The outer rim has at least one rib which is easily formed and saves the post machining steps to reduce the manufacturing cost and the defect rate.

Yet another object of the present invention is to provide a bicycle rim made by aluminum and carbon fibers. The outer rim has a connection portion formed in the inner periphery thereof and the connection portion has two ribs so as to be connected to the inner rim to reinforce the strength of the bicycle rim.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bicycle rim of the present invention;

FIG. 2 is a perspective view to show a section of the bicycle rim of the present invention;

FIG. 3 is an exploded view to show the bicycle rim of the present invention;

FIG. 4 is a cross sectional view of the bicycle rim of the present invention;

FIG. 5 is a perspective view to show a section of the second embodiment of the bicycle rim of the present invention;

FIG. 6 is an exploded view to show the bicycle rim of the present invention in FIG. 5;

FIG. 7 is a side plane view to show a section of the bicycle rim of the present invention in FIG. 5;

FIG. 8 is an end cross sectional view to show one embodiment of the bicycle rim of the present invention;

FIG. 9 is a cross sectional view to show another embodiment of the bicycle rim of the present invention;

FIG. 10 is a side cross sectional view to show the bicycle rim of the present invention, wherein the cut-away is not yet removed, and

FIG. 11 is a side cross sectional view to show the bicycle rim of the present invention, wherein the cut-away is formed.

### DETAILED DESCRIPTION OF THE PREFERRED EMBODIMENT

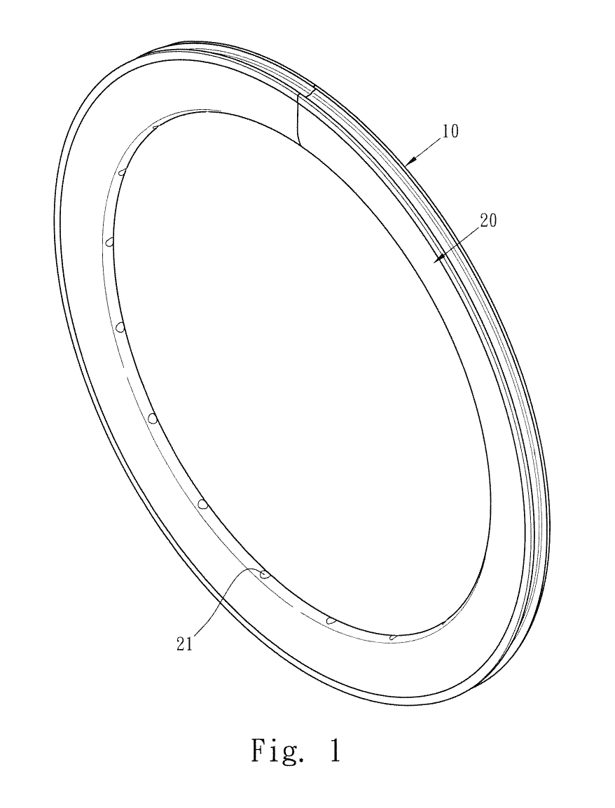

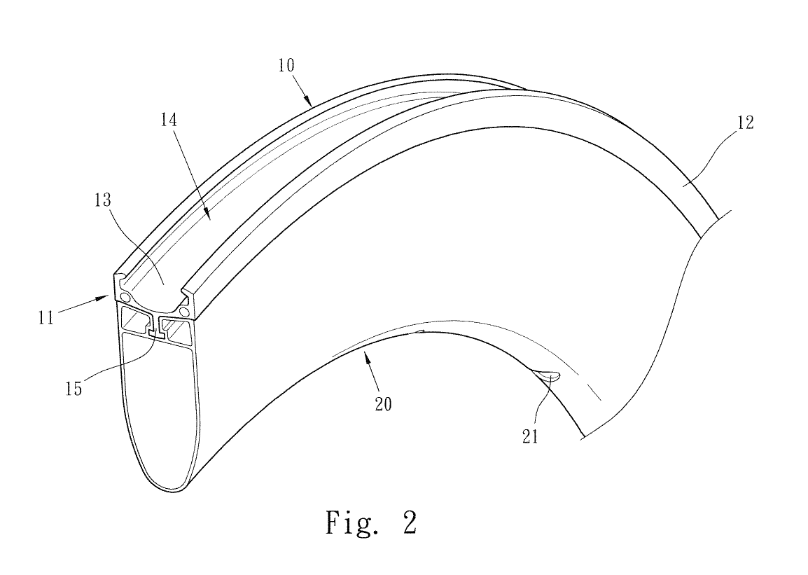

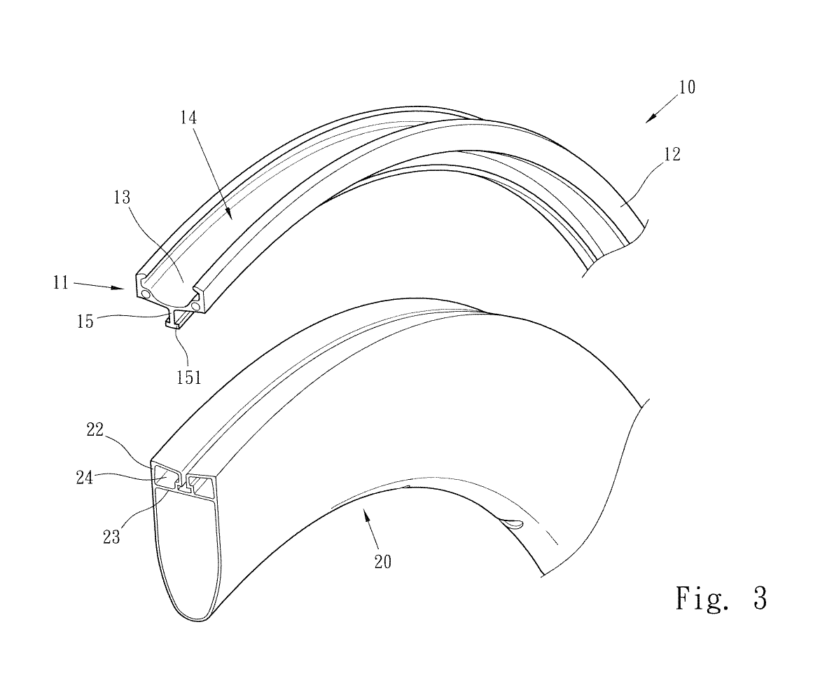

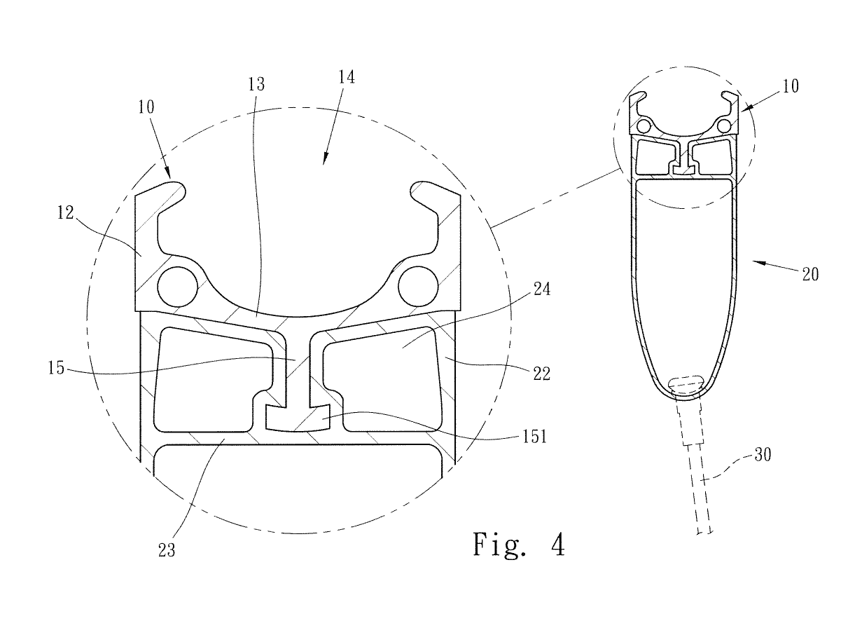

Referring to FIGS. 1 to 4, the bicycle rim of the present invention comprises an outer rim 10 and an inner rim 20 which is connected to the inner periphery of the outer rim 10.

The outer rim 10 is made by aluminum alloy and initially formed as an elongate member by way of extruding and which has two connection ends 11 on two ends thereof. The two connection ends 11 are connected to each other to form a ring-shaped rim. The outer rim 10 has two sidewalls 12 on two sides thereof and each outside wall 12 has a brake surface for being in contact with the brake pad. A connection ring 13 is located between two insides of the two sidewalls 12, and a tire groove 14 is defined between the connection ring 13 and the two sidewalls 12, so that a tire is engaged with the tire groove 14. The outer rim 10 has at least one rib 15 located in opposite to the tire groove 14 and the at least one rib 15 has a hook-shaped flange 151 extending from each of the two sides thereof. In this embodiment, one rib 15 extends from the center of the outer rim 10.

The ring-shaped inner rim 20 is made by carbon fibers and secured to the inner periphery of the outer rim 10 when the carbon fibers are heated and hardened. Multiple holes 21 are defined through the inner periphery of the inner rim 20 so as to be connected with the spokes 30. The inner rim 20 has two outside walls 22 and a first mediate portion 23. The first mediate portion 23 is connected between the two outside walls 22, and the two outside walls 22 are connected to the inner periphery of the outer rim 10. The rib 15 and the flanges 151 are enclosed by the two outside walls 22 and the first mediate portion 23. Two spaces 24 are defined between the rib 15, the two outside walls 22 and the first mediate portion 23.

The aluminum made outer rim 10 has at least one rib 15 and the inner rim 20 is made by carbon fibers which are connected to the outer rim 10 and the at least one rib 15 is enclosed by the carbon fibers, such that the outer and inner rims 10, 20 are securely combined together.

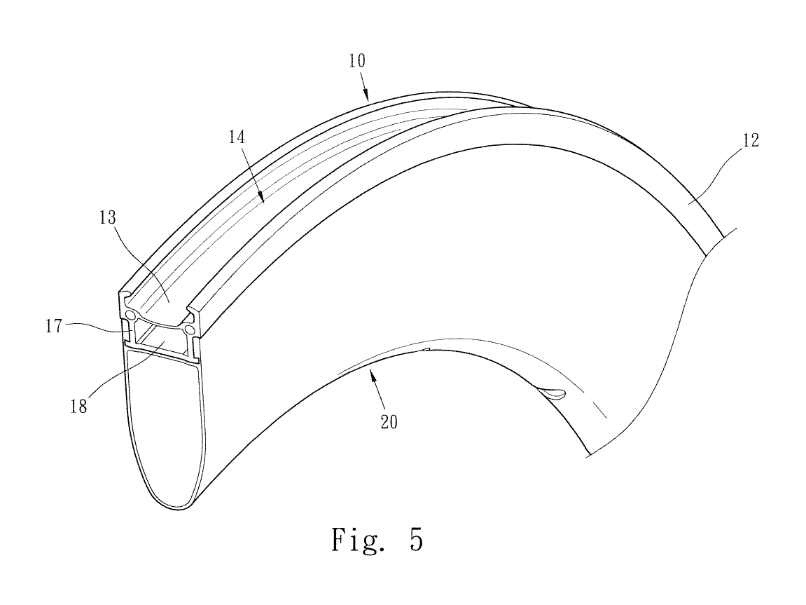

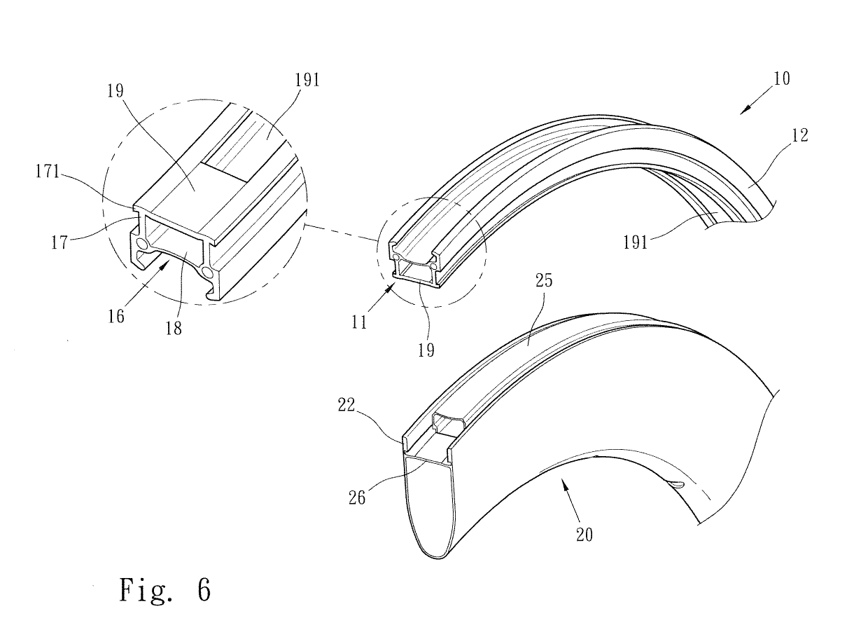

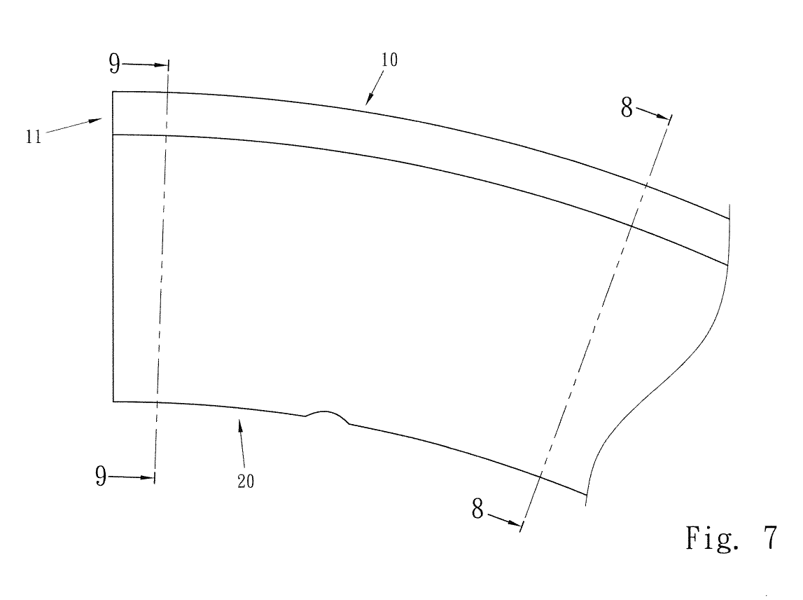

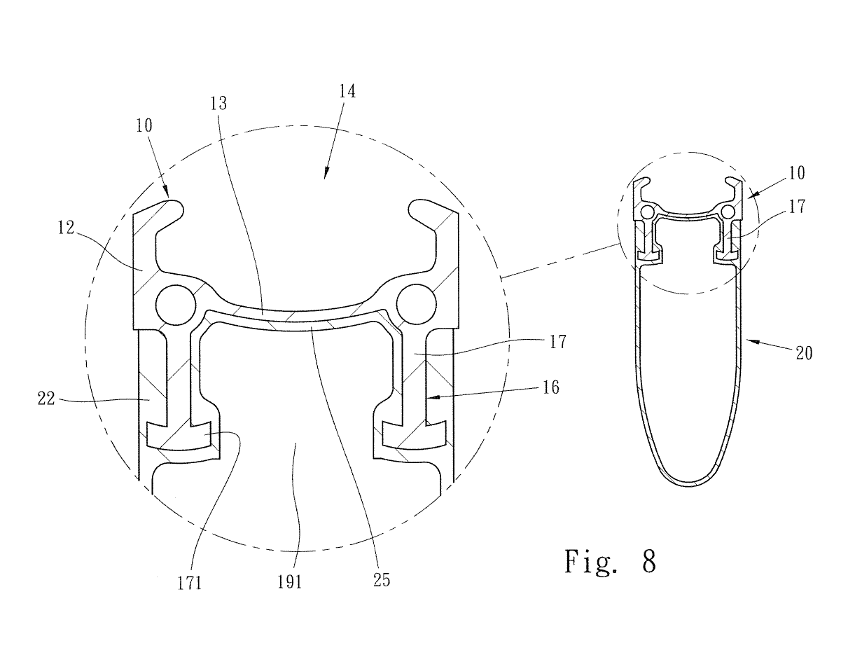

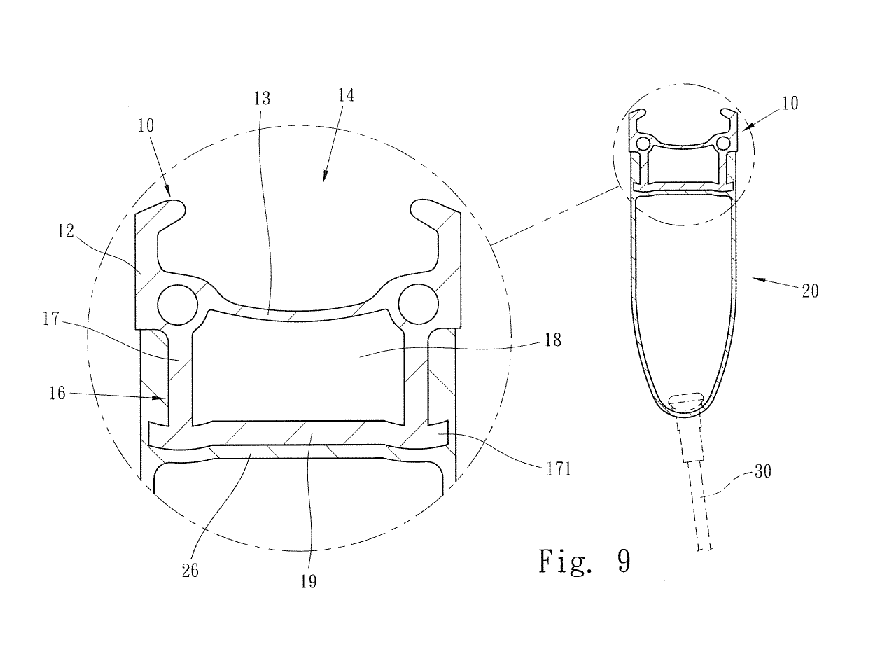

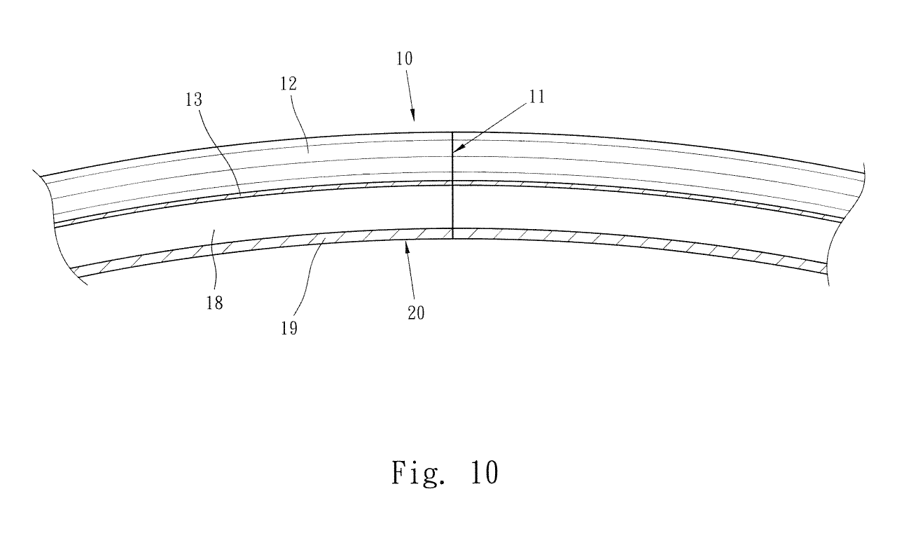

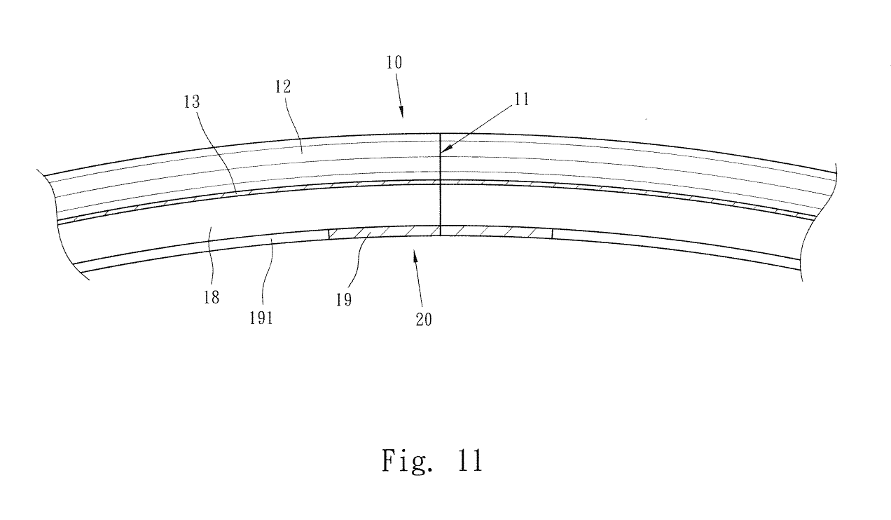

As shown in FIGS. 5 to 9, a second embodiment of the present invention is disclosed, wherein the outer rim 10 has a connection portion 16 located in opposite to the tire groove 14. The connection portion 16 has two ribs 17 extending therefrom and each of the ribs 17 has a flange 171 extending from at least one side thereof. In this embodiment, a space 18 is defined between the connection ring 13 and the ribs 17. A bridge 19 is connected between the two ribs 17 and has a cut-away 191 which is defined between the two connection ends 11 so as to reduce the weight of the bicycle rim. The connection portion 16 is integrally formed with the outer rim 10 when extruding the outer rim 10. The space 18 is eventually defined between the connection ring 13 and communicates with the cut-away 191 as shown in FIGS. 10 and 11. The inner rim 20 has two outside walls 22, a second mediate portion 25 and a third mediate portion 26. The second mediate portion 25 located between the two ribs 17 and within the cut-away 191. The outside walls 22 and the second mediate portion 25 are connected to the inner periphery of the outer rim 10 and enclose the ribs 17 and the flanges 171. The third mediate portion 26 is connected between the two outside walls 22 at the connection ends 11 and encloses the ribs 17, the flanges 171 and the bridge 19 to securely connect the inner rim 20 to the outer rim 10.

The outer rim 10 has at least one rib 15 which has a flange 151 extending from each of the two sides thereof, and the inner rim 20 made by carbon fibers is connected to the at least one rib 15 and the flanges 151, so that the connection between the aluminum-made rib 15 and flanges 151 and the carbon fibers of the inner rim 20 is secured.

The rib 15 on the outer rim 10 is conveniently formed during the extrusion process and this reduces the manufacturing cost. The connection portion 16 is integrally formed with the outer rim 10 and the cut-away 191 is made after the connection portion 16 is formed. The connection portion 16 has two ribs 17 and the carbon fibers are connected to the ribs 15 and 17 so that the outer rim 10 and the inner rim 20 are not deformed during manufacturing processes to reduce the defect rate.

While we have shown and described the embodiment in accordance with the present invention, it should be clear to those skilled in the art that further embodiments may be made without departing from the scope of the present invention.

What is claimed is:

1. A bicycle rim comprising:
an outer rim made by aluminum and initially formed as an elongate member which has two connection ends on two ends thereof, the two connection ends connected to each other to form a ring-shaped rim, the outer rim having two sidewalls on two sides thereof and a connection ring located between two insides of the two sidewalls, a tire groove defined between the connection ring and the two sidewalls, the outer rim having at least one rib located in opposite to the tire groove and the at least one rib having a hook-shaped flange extending from at least one side thereof, and
an inner rim made by carbon fibers and being a ring-shaped rim, the inner rim located at an inner periphery of the outer rim and enclosing the at least one rib.

2. The bicycle rim as claimed in claim 1, wherein the at least one rib has a hook-shaped flange on one side thereof.

3. The bicycle rim as claimed in claim 1, wherein the outer rim has a rib which is located in opposite to the tire groove and the rib has two flanges on two sides thereof, the inner rim has two outside walls and a first mediate portion, the first mediate portion connected between the two outside walls, the two outside walls connected to the inner periphery of the outer rim, the rib and the flanges are enclosed by the two outside walls and the first mediate portion.

4. The bicycle rim as claimed in claim 3, wherein two spaces are defined between the rib, the two outside walls and the first mediate portion.

5. The bicycle rim as claimed in claim 1, wherein the outer rim has a connection portion located in opposite to the tire groove, the connection portion has two ribs extending therefrom and each of the ribs has a flange extending therefrom, a groove is defined between the two ribs, the inner rim has two outside walls and a second mediate portion which is connected to the two outside walls, the ribs and the flanges are located between the outside walls and the second mediate portion, the groove being enclosed by the second mediate portion.

6. The bicycle rim as claimed in claim 1, wherein the outer rim has a connection portion located in opposite to the tire groove, the connection portion has two ribs extending therefrom and each of the ribs has a flange extending therefrom, a space is defined between the connection ring and the ribs, a bridge is connected between the two ribs and has a cut-away which is defined between the two connection ends, the inner rim has two outside walls, a second mediate portion and a third mediate portion, the outside walls and the second mediate portion are connected to the inner periphery of the outer rim, the second mediate portion encloses the ribs and the cut-away, the outside walls are connected to the third mediate portion at the two connection ends, and connected to outside of the ribs and the flanges.
